(19) United States
(12) Patent Application Publication
(10) Pub. No.: US 2004/0255424 A1
(43) Pub. Date: Dec. 23, 2004

(54) Windscreen wiper device, in particular for a motor vehicle

(76) Inventors: Achim Kraus, Buehl (DE); Sofiene Gharbi, Karlsruhe (DE)

Correspondence Address: MICHAEL BEST & FRIEDRICH, LLP, 100 E WISCONSIN AVENUE, MILWAUKEE, WI, 53202, US

(21) Appl. No.: 10/485,990

(22) PCT Filed: Sep. 20, 2002
(86) PCT No.: PCT/DE02/03541

(30) Foreign Application Priority Data
Feb. 26, 2002 (DE) 102 06 628.0

(51) Int. Cl. B60S 1/06; B60S 1/18; B60S 1/58

(52) U.S. Cl. 15/250.31; 15/250.3

(57) ABSTRACT

A windshield wiper device for a motor vehicle is proposed with at least one drive part (10), which features a first coupling part (18) and at least one wiper part (12), which bears a wiper shaft (22) and features a second coupling part (20), which is essentially rigidly connected to the wiper shaft (22), whereby the second coupling part (20) can be brought eccentrically into effective connection with the first coupling part (18).

### STATE OF THE ART

The invention relates to a windshield wiper device, in particular for a motor vehicle, in accordance with the species of the independent claim.

A windshield wiper device is known from DE 100 34 041 A1, in which a wiper arm, including the associated support, is fastened to the wiper part, which is supported by an articulated rear window. A drive part with an electric motor is connected in a stationary manner with the body and features a pot-shaped first coupling element, which can be brought into effective connection with a second coupling part. The second coupling part is permanently and concentrically connected to the wiper shaft, which bears the wiper arm with the wiper blade. The wiper shaft is positioned elastically in the wiper part, which is fastened to the rear window of a motor vehicle.

### ADVANTAGES OF THE INVENTION

The windshield wiper device in accordance with the invention with the feature of the main claim has the advantage that, due to an eccentric connection between the wiper shaft and a second coupling part, higher forces and thus higher torques can be transmitted through the coupling. Simple projections like noses or pins can be used in this way as the second coupling element.

Advantageous further developments and improvements of the features indicated in the main claim are yielded by the measures listed in the subclaims.

It is particularly advantageous if the wiper shaft is positioned spring elastically in the axial direction since in any event the wiper shaft features a stable support in the radial direction so that a support of the second coupling part can be dispensed in this way.

It is also advantageous if the second coupling part is itself embodied as an essentially rigid element in order to transmit a maximum torque to the wiper shaft.

In addition, it is advantageous if the second coupling part is able to penetrate the first coupling part, in particular is able to penetrate through the first coupling part. This results in a positively engaged connection between the first and second coupling part so that maximum torques can be transmitted from the drive part to the wiper shaft.

It is particularly advantageous if the first coupling part is embodied as a perforated disk. This is simple and cost-effective to manufacture.

It is also advantageous if the first and second coupling parts ( ) can be brought into engagement by rotating the first coupling part ( ) against the second coupling part ( ). In practice this means that the coupling thereby engages itself when the second coupling part, which is rigidly connected to the wiper shaft, has rotated in a disengaged state, i.e., the wiper would rotate in a disengaged position.

In addition, it should be viewed as advantageous if the drive part is used to drive the wiper shaft and is able to bring itself into effective connection with the wiper shaft. In this way, the coupling is able to engage itself when the drive part is started.

It is especially advantageous if the drive part features an electric motor, in particular a reversing motor.

In addition, it is advantageous if the drive part can be fastened to a tailgate and the wiper part to a rear window of the motor vehicle.

### DRAWINGS

One exemplary embodiment of the invention is depicted in the drawings and explained in greater detail in the following description.

The drawings show:

FIG. 1A perspective representation of a windshield wiper device in accordance with the invention.

FIG. 2A side view of the wiper portion of a windshield wiper device in accordance with the invention.

### DESCRIPTION OF THE EXEMPLARY EMBODIMENT

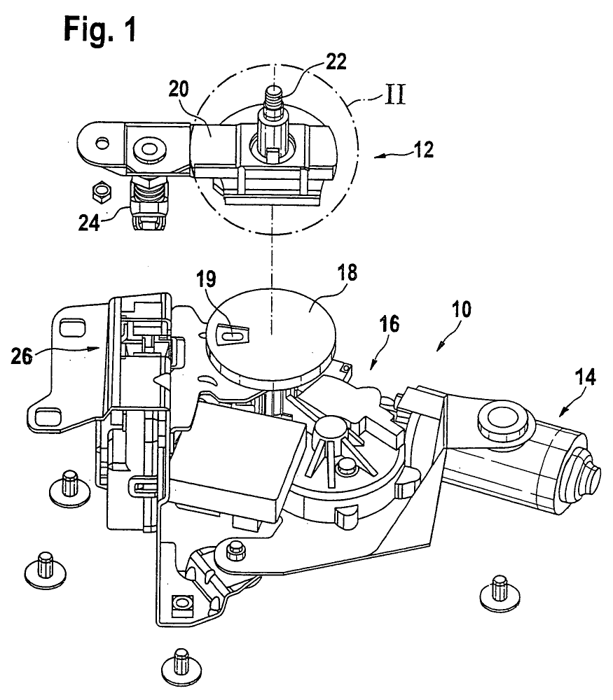

FIG. 1 shows a perspective representation of a windshield wiper device in accordance with the invention. It essentially features a drive part 10 and a wiper part 12. The drive part 10 is made of up an electric motor 14, which can be embodied as a reversing motor or as a rotating electric motor. This is connected to a gear 16, which is embodied as a worm gear, for example. The gear 16 conveys the torque being output by the electric motor 14 to a first coupling part 18, which is embodied as a perforated disk. The perforated disk 18 has an essentially circular, disk-shaped form and features an oblong opening 19 eccentric to its rotational axis.

The wiper part 12 is made up essentially of a holder 20, in which a wiper shaft 22 is positioned. In addition, a locking part 24 is arranged on the holder 20 parallel to the wiper shaft 22, which cooperates with a lock 26, which is arranged on the drive part 10.

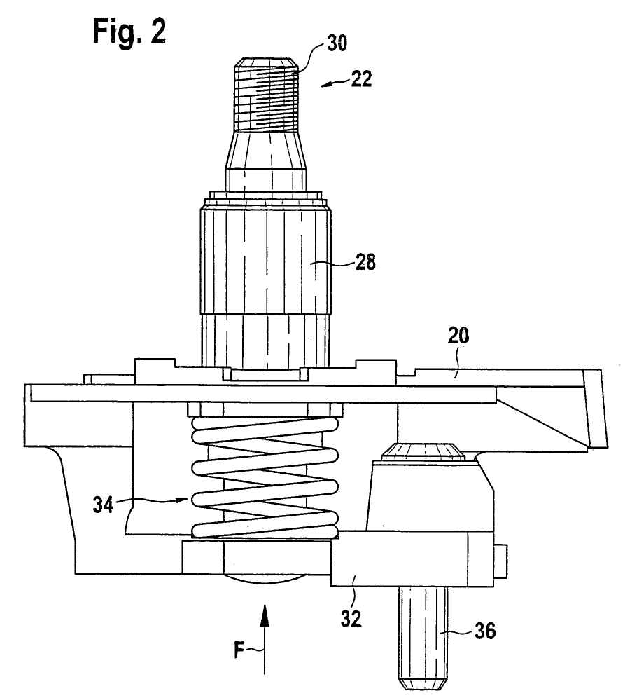

A detailed section of the wiper part 12 from FIG. 1 is shown in FIG. 2. The wiper shaft 22 is positioned in a bearing 28, which is fastened on the holder 20 or is embodied as a single piece with it. The wiper shaft is conically tapered on one end and features a threaded section 30 so that a wiper arm (not shown here) can be connected in a torque-proof manner to the wiper shaft 22 on this outer side.

The wiper shaft 22 is connected in a torque-proof manner on the other end to a bridge 32, which can also be embodied as a circular disk. Arranged concentrically on the wiper shaft 22 is a compression spring 34, which supports itself between the holder 20 and the bridge 32 in such a way that when force F is exerted on the bridge 32 and thus on the wiper shaft 22, the compression spring 34 is compressed and the wiper shaft 22 is displaced axially to the outside.

A carrier pin is arranged as a second coupling part 36 on the bridge 32 parallel to the wiper shaft 22, but on the side of bridge 32 opposite from the wiper shaft 22. This carrier pin is pressed rigidly into the bridge 32 or fastened in another manner known in the state of the art. In order to reduce noise, it can also be sheathed in rubber or inserted into a plastic bushing.

The cooperation of the drive part 10 and the wiper part 12 will be explained in the following.

The wiper part 12 is typically arranged on the rear window of a motor vehicle. The drive part 10 is arranged on the tailgate itself. The rear window is equipped with hinges. These are provided to close the rear window opening in the tailgate. If the rear window is now closed, the second coupling part 36 engages in the opening of the first coupling part 18. In this way, the torque is then transmitted via the first coupling part 18 and the second coupling part 36.

If, however, the wiper shaft 22 was moved with a disconnected coupling, i.e., when the first coupling part 18 is not in engagement with the second coupling part 36, then the metal bolt of the second coupling part 36 is not in the same position as in the case of the disconnection of the coupling part 18, 20. In this case, the second coupling part 36 will be resting on the first coupling part 18 that is embodied as a perforated disk. With a complete joining of the wiper part 12 and drive part 10, the compression spring 24 is compressed and the wiper shaft 22 is displaced to the outside.

Due to the compressed compression spring 34, an axial force is exerted on the second coupling part 36. As a result, the carrier pin 36 is pressed on the perforated disk 18. If the drive part 10 now begins to rotate the first coupling part 18, then it rotates away under the second coupling part 20. If the opening 19 of the first coupling part 18 is situated under the second coupling part 36, then this snaps into the opening 19 of the first coupling part 18, thereby producing the coupling, and the torque is again transmitted to the wiper shaft 22.

1. Windshield wiper device, in particular for a motor vehicle, with at least one drive part (10), which features a first coupling part (18) and at least one wiper part (12), which bears a wiper shaft (22) and features a second coupling part (20), which is essentially rigidly connected to the wiper shaft (22), characterized in that the second coupling part (20) can be brought eccentrically into effective connection with the first coupling part (18).

2. Windshield wiper device according to claim 1, characterized in that the wiper shaft (22) is positioned spring elastically in the axial direction.

3. Windshield wiper device according to claim 1, characterized in that the second coupling part (20) is embodied as an essentially rigid element.

4. Windshield wiper device according to claim 1, characterized in that the second coupling part (20) is able to penetrate the first coupling part (18), in particular is able to penetrate through the first coupling part (18).

5. Windshield wiper device according to claim 1, characterized in that the first coupling part (18) is embodied as a perforated disk.

6. Windshield wiper device according to claim 1, characterized in that the first and second coupling parts (18, 20) can be brought into engagement by rotating the first coupling part (18) against the second coupling part (20).

7. Windshield wiper device according to claim 1, characterized in that the drive part (10) is used to drive the wiper shaft (22) and is able to bring itself into effective connection with the wiper shaft (22).

8. Windshield wiper device according to claim 1, characterized in that the drive part (10) features an electric motor (14), in particular a reversing motor.

9. Windshield wiper device according to claim 1, characterized in that the drive part (10) can be fastened to a tailgate and the wiper part (12) to a rear window of the motor vehicle.
